(19) United States
(12) Patent Application Publication
(10) Pub. No.: US 2015/0191153 A1
(43) Pub. Date: Jul. 9, 2015

(54) Motorcycle Windscreen Wiper System

(71) Applicant: Gary Norman, Umatilla, FL (US)

(72) Inventor: Gary Norman, Umatilla, FL (US)

(21) Appl. No.: 14/592,339

(22) Filed: Jan. 8, 2015

Related U.S. Application Data
(60) Provisional application No. 61/925,306, filed on Jan. 9, 2014.

(51) Int. Cl. B60S 1/04; B62J 17/04

(52) U.S. Cl. CPC B60S 1/0438; B62J 17/04

(57) ABSTRACT

A motorcycle windscreen wiper system is provided that comprises a wiper blade assembly, a wiper motor, and a handlebar controller that is used to clear water, dirt, and road debris from a motorcycle windscreen. The windscreen is substantially planar and supports the elongated wiper assembly, while the wiper motor is secured directly to the windscreen along the lower portion of its interior surface. The motor is directly connected to the wiper blade assembly and the wiper assembly moves along a defined arc along the windscreen. The motor includes a motor controller and is powered by the motorcycle battery, while the handlebar controller provides a handlebar mounted assembly that a rider can use to activate and control the wiper assembly while riding.

### CROSS REFERENCE TO RELATED APPLICATION

This application claims the benefit of U.S. Provisional Application No. 61/925,306 filed on Jan. 9, 2014. The above identified patent application is herein incorporated by reference in its entirety to provide continuity of disclosure.

### BACKGROUND OF THE INVENTION

### Field of the Invention

The present invention relates to vehicle windshield wipers and devices for clearing water and debris from the exterior of a windshield. More specifically, the present invention relates to a motor controlled wiper assembly for a motorcycle windscreen that is controlled by a handlebar control and operates a wiper blade along the exterior of the motorcycle windscreen.

It can often be difficult to see through the windscreen of a motorcycle during rain events or when water is spraying onto the windscreen from other vehicles. For those motorcycles with larger windscreens, this can impair vision of the rider and create a dangerous situation. To avoid this concern, many riders pull over during rain events or avoid riding in inclement weather. However, this is not always a desired or even practical solution for some.

Windshield wipers exist in the art for various vehicle types. These generally include wiper assemblies for motor vehicles and for boats, whereby one or more wiper blades are pivoted along the exterior of the windshield using an electric motor and a linkage assembly. The linkage transforms rotational motion of the motor into a partial sweep of each wiper blade across the windshield. Still other motors exist that directly drive the wiper blades through a partial sweep, without requiring an intermediate linkage.

The present invention contemplates a wiper blade assembly and controller therefor that is affixable to an existing motorcycle, whereby the motor assembly and wiper assembly are connected to the windscreen and the controls are connected to the handlebars adjacent to the handle grips. A single wiper blade is positioned along the exterior of the windscreen, while the motor assembly is disposed along the interior surface of the windscreen and is connected to the wiper blade through the windscreen. Electrical power is drawn from the motorcycle battery, while the handlebar controls allow the rider to activate and control the speed of the wiper blade.

### SUMMARY OF THE INVENTION

In view of the disadvantages inherent in the known types of windshield wiper blade systems now present in the prior art, the present invention provides a new motorcycle windscreen wiper system that can be utilized for providing convenience for the user when clearing water and debris from a motorcycle windscreen using a handlebar controllable assembly that is affixed to the motorcycle windscreen.

It is therefore an object of the present invention to provide a new and improved motorcycle windscreen wiper system that has all of the advantages of the prior art and none of the disadvantages.

It is another object of the present invention to provide a motorcycle windscreen wiper system that secures to the windscreen of a motorcycle and provides a moving wiper blade along the exterior thereof to clear water and debris.

Another object of the present invention is to provide a motorcycle windscreen wiper system that positions a wiper motor along the interior of the windscreen, powering a wiper blade assembly along the exterior of the windscreen, whereby the assembly can be utilizes on new motorcycles or retrofitted to existing vehicles.

Yet another object of the present invention is to provide a motorcycle windscreen wiper system that includes handlebar controls that control the operation and speed of the wiper motor.

Another object of the present invention is to provide a motorcycle windscreen wiper system that preferably draws power from the motorcycle battery, whereby the system can be retrofitted to an existing motorcycle and powered directly via connection to the battery terminals.

Another object of the present invention is to provide a motorcycle windscreen wiper system that may optionally be provided as a uniquely designed windscreen replacement, whereby the motor and wiper assembly are customized for the exact design of the windscreen and the assembly can be installed in place of an existing windscreen.

A final object of the present invention is to provide a motorcycle windscreen wiper system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal view of the windscreen wiper system deployed on the front of a motorcycle.

FIG. 2 shows a side view of the system on a motorcycle windscreen.

FIG. 3 shows a view of the handlebar controls of the system.

### DETAILED DESCRIPTION OF THE INVENTION

Reference is made herein to the attached drawings. Like reference numerals are used throughout the drawings to depict like or similar elements of the motorcycle windscreen wiper system of the present invention. For the purposes of presenting a brief and clear description of the present invention, the preferred embodiment will be discussed as used for clearing water and debris from a motorcycle windscreen using a wiper assembly controllable from the motorcycle handlebars. The figures are intended for representative purposes only and should not be considered to be limiting in any respect.

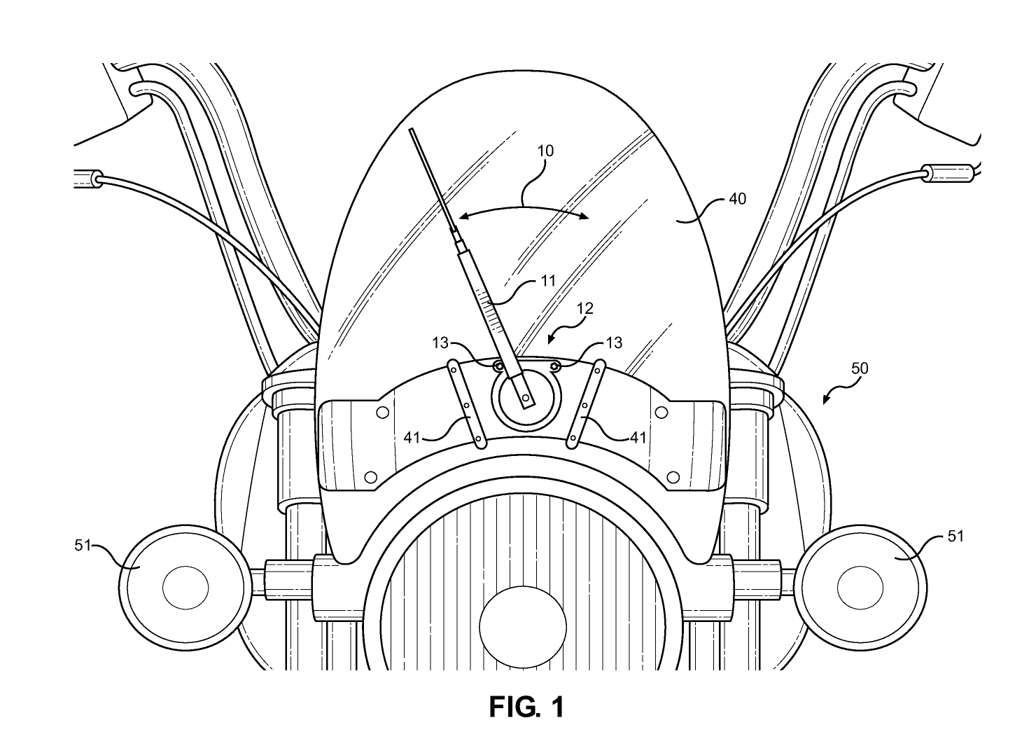

Referring now to FIG. 1, there is shown a frontal view of a motorcycle front end 50, which generally comprises one or more fairings, headlights 51, and a windscreen 40 to shield the rider. The present invention relates to a new and improved weather and debris clearing system for a motorcycle windscreen, whereby a wiper blade 11 is disposed along the exterior surface thereof to remove rain, dirt, and road debris that may otherwise obscure a rider's field of vision. Windscreens 40 on motorcycles are popular accessories that provide a barrier between the rider and the air pressure developed as the rider moves through therethrough at higher speeds. At these higher speeds, the rider's body otherwise bears the brunt of this high pressure air. Windscreens 40 offer an angled surface that diverts air over the top of the rider as the rider and motorcycle are traveling therethrough at a high rate of speed. Therefore, the air pressure on the rider is reduced, and his or her comfort increases.

The present invention provides a system that compliments an existing windscreen, or alternatively works in conjunction with a specifically designed windscreen that can support the elements of the wiper system. Windscreens 40 are generally supported by one or more mounts 41 that bolt directly to the windscreen 40 and support the windscreen while significant air pressure load is imparted onto the windscreen. Generally the mounts 41 support the windscreen 40 with sufficient clearance between the windscreen 40 and the front end of the motorcycle, allowing for components such as the rider display and tachometer to be mounted thereunder. The present invention contemplates a small wiper motor assembly 12 mounted along the interior surface of the windscreen and along the base, whereby the motor assembly powers a small windscreen wiper blade 11 along the exterior of the windscreen.

Specifically, the present invention contemplates a wiper motor assembly 12 that comprises an electric motor that is bolted 13 directly to the windscreen 40. The electric motor is wired to the battery of the motorcycle and includes a motor controller that controls the motion thereof. The motion is one of an arc 10, whereby the motor is directly connected to the proximal end of a wiper blade 11 and the motor drives the wiper blade 11 through a defined arc 10 without intermediate linkages. The arc 10 is a defined sweep in which the wiper rotates back and forth less than 180 degrees and without intermediate linkages between the wiper and the wiper motor. By receiving electrical power directly from the battery of the motorcycle, the assembly can be mounted to an existing motorcycle without requiring a specific electrical connection in the existing wiring, and can piggyback onto the battery and receive direct power therefrom.

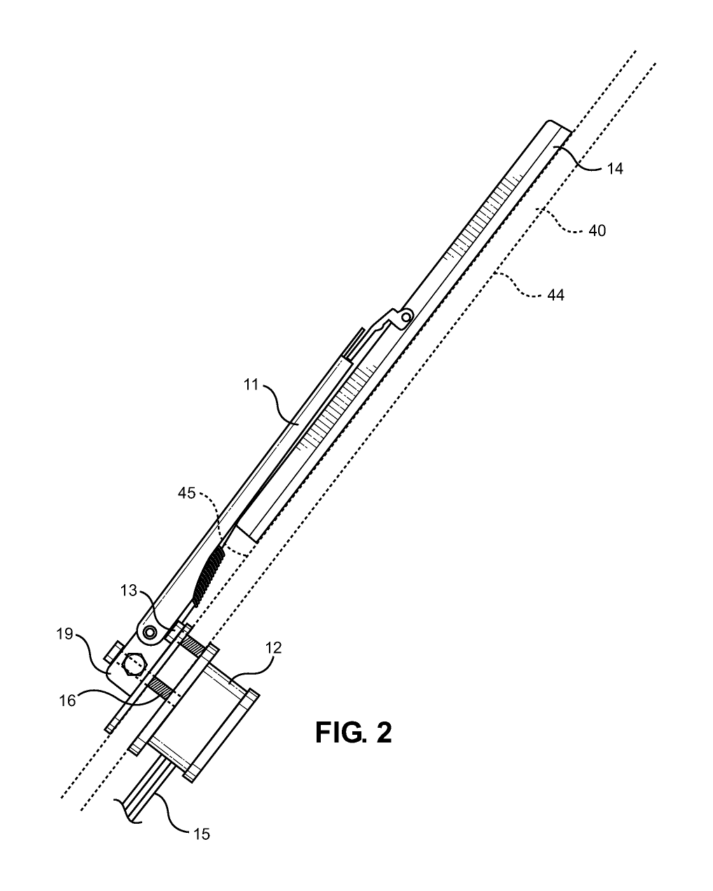

Referring now to FIG. 2, there is shown a side view of the motorcycle windscreen wiper system of the present invention mounted to a windscreen 40. The windscreen 40 is an elongated surface comprising Plexiglas or similar plastic material that is transparent and resilient to impacts and applied air pressure. Generally the windscreen 40 extends from its mounting in an upwardly and rearwardly direction such that wind is directed over the rider behind the windscreen. The wiper system of the present invention places a wiper motor 12 along the base of the windscreen and along a flat portion thereof. The windscreen 40 of the present invention is substantially planar such that the wiper blade 11 contacts the exterior surface 45 thereof along its sweep.

The electric wiper motor 12 is mounted directly to the interior surface 44 of the windscreen 40, whereby the motor comprises a driveshaft 16 and electrical connections 15. The connections are routed and connected to the terminals of the motorcycle battery. The driveshaft 16 is disposed through an aperture in the windscreen and connects to the proximal end 19 of the wiper blade assembly 11. The wiper blade assembly 11 comprises an elongated member having a wiper blade 14 and a wiper blade support. The blade 14 contacts the outer surface 45 of the windscreen and physically removes water, dirt, and road debris therefrom along its sweep. Therefore, a planar windscreen is most optimal for this task, whereby the blade 14 remains in contact with the windscreen while in motion.

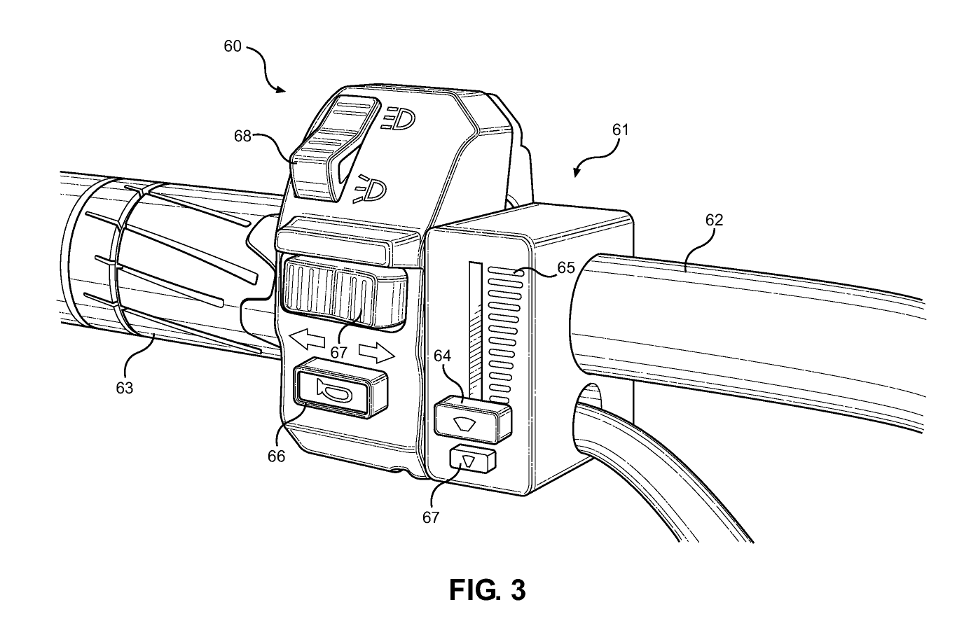

Referring now to FIG. 3, there is shown a view of the handlebar control 61 of the present invention, which allows the rider to select the operation and speed of the wiper assembly from a control mounted adjacent to the left grip 63 on the motorcycle handlebar 62. To operate the device, it is desired to provide a handlebar control 61 that allows a rider to turn on and then control the speed of the wiper blade motion without removing the rider's hands from the handlebars.

Specifically, the handlebar controller 61 comprises a housing that is electrically connected to the wiper motor and provides a slider 64 and/or a toggle switch 67 to operate the wiper motor. The toggle switch 67 is a press-button controller that switches the motor on and off. The slider 64 is a sliding switch that controls the speed of the wiper motor, and thus the speed with which the wiper blade traverses its sweep. Adjacent to the slider 64 and along the exterior of the toggle switch 67 are indicia 65 that allow the rider to recognize the functions of each with minimal experience.

The handlebar controller 61 for the wiper assembly comprises a housing that clamps onto the handlebar 62 or clip-on handlebar of the motorcycle and can be positioned adjacent to the existing control housing 60 thereof. The existing controls are generally located just inboard of the left handlebar grip 63, and provide the rider with one or more basic controls. At a minimum, these generally include a turn signal controller switch 67, a high and low beam headlight switch 68, and a horn button 66. The controller 61 of the present invention can be installed just inboard of the existing controls 60 such that activation and speed of the wiper assembly can be controlled by the rider's left thumb, without requiring the rider to completely remove his or her hand from the handlebar grip 63.

Overall, the present invention provides a windscreen wiper for a motorcycle windscreen that includes an external motor, power switch, and connectors that can be connected directly to a motorcycle battery. The wiper eliminates the need to stop and wipe off the windscreen, increases visibility, and helps reduce accidents, particularly at night. The battery powered windscreen wiper comprises a handlebar controller that enables the activation and control over the wiper, thereby enabling use of the system without compromising safety or requiring the user to remove his or her hands from the handlebars to operate.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A windscreen wiper system for a motorcycle, comprising:
a substantially transparent windscreen having a lower end, an upper end, an interior surface, and an exterior surface;
a wiper motor comprising an electric motor with a motor controller and a drive shaft;
a wiper assembly comprising an elongated wiper blade disposed along the exterior surface of said windscreen and in contact therewith;
said wiper motor being connected to said windscreen along the lower end of its interior surface;
said drive shaft positioned through an aperture in the lower end of said windscreen, said drive shaft connected to a proximal end of said wiper assembly;
said wiper motor having a defined sweep in which said driveshaft rotates back and forth less than 180 degrees without intermediate linkages;
the exterior surface of said windscreen in contact with said wiper assembly being substantially planar;
a handlebar controller on a handlebar of said motorcycle for controlling said wiper motor.

2. The motorcycle windscreen wiper system of claim 1, wherein said wiper motor is electrically connected to a battery within said motorcycle.

3. The motorcycle windscreen wiper system of claim 1, wherein said handlebar controller further comprises a wiper motor activation toggle that controls activation of said wiper motor.

4. The motorcycle windscreen wiper system of claim 1, wherein said handlebar controller further comprises a wiper motor speed slider that controls a speed of said wiper motor.

5. The motorcycle windscreen wiper system of claim 1, wherein said handlebar controller further comprises a housing that is affixed to the handlebar of said motorcycle inboard of existing controls along a left grip thereof.
